(19) United States
(12) Patent Application Publication
(10) Pub. No.: US 2004/0104380 A1
(43) Pub. Date: Jun. 3, 2004

(54) Force-indicating strap fastener

(76) Inventor: Han-Ching Huang, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/307,691

(22) Filed: Dec. 2, 2002

(51) Int. Cl. B66F 3/00

(52) U.S. Cl. 254/218; 24/68 R

(57) ABSTRACT

A force-indicating strap fastener includes a base, an axle, a lever, two ratchet wheels, a first detent, a second detent, and a force gauge. The base including a first guiding element formed thereon and a second guiding element formed thereon. The axle is rotationally mounted on the base. The lever is pivotally mounted on the axle. The ratchet wheels are secured to the axle. The first detent is mounted on the base for engagement with the ratchet wheels. Thus, rotation of the axle relative to the base in a first direction is allowed, but rotation of the axle in a second direction opposite to the first direction is avoided. The second detent is mounted on the lever for engagement with the ratchet wheels. Thus, pivoting of the lever in the first direction results in rotation of the axle in the first direction, but pivoting of the lever in the second direction does not entail rotation of the axle in the second direction. The force gauge includes a casing, a spring, an anvil and an indicator. The casing is mounted on the base and formed with a scale. The spring is received in the casing. The anvil includes a first end in contact with the spring and a second end outside the casing. The indicator is connected with the anvil for pointing at a value in the scale depending on the tensile force.

### BACKGROUND OF INVENTION

1. Field of Invention

The present invention relates to a force-indicating strap fastener.

2. Related Prior Art

Taiwanese Patent Publication No. 383756 discloses a conventional strap fastener. This conventional strap fastener is used to fasten a strap wrapped around an article. This conventional strap exerts a tensile force on the strap that in turn exerts a force on the article. If the tensile force is too small to restrict the article, the article will get loose and become vulnerable to damages. However, the tensile force may be too large for the strap to sustain. In such a case, the strap may be fractured. When that happens, the at least one article will get loose and become vulnerable to damages. What is worse is that the loose article may cause severe damages to people.

The present invention is therefore intended to obviate or at least alleviate the problems encountered in prior art.

### SUMMARY OF INVENTION

It is the primary objective of the present invention to provide a force-indicating strap fastener.

According to the present invention, a force-indicating strap fastener includes a base, an axle, a lever, two ratchet wheels, a first detent, a second detent, and a force gauge. The base including a first guiding element formed thereon and a second guiding element formed thereon. The axle is rotationally mounted on the base. The lever is pivotally mounted on the axle. The ratchet wheels are secured to the axle. The first detent is mounted on the base for engagement with the ratchet wheels. Thus, rotation of the axle relative to the base in a first direction is allowed, but rotation of the axle in a second direction opposite to the first direction is avoided. The second detent is mounted on the lever for engagement with the ratchet wheels. Thus, pivoting of the lever in the first direction results in rotation of the axle in the first direction, but pivoting of the lever in the second direction does not entail rotation of the axle in the second direction. The force gauge includes a casing, a spring, an anvil and an indicator. The casing is mounted on the base and formed with a scale. The spring is received in the casing. The anvil includes a first end in contact with the spring and a second end outside the casing. The indicator is connected with the anvil for pointing at a value in the scale depending on the tensile force.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a strap fastener equipped with a force gauge according to the present invention.

FIG. 2 is a side view of the strap fastener and the force gauge shown in FIG. 1 in a first position.

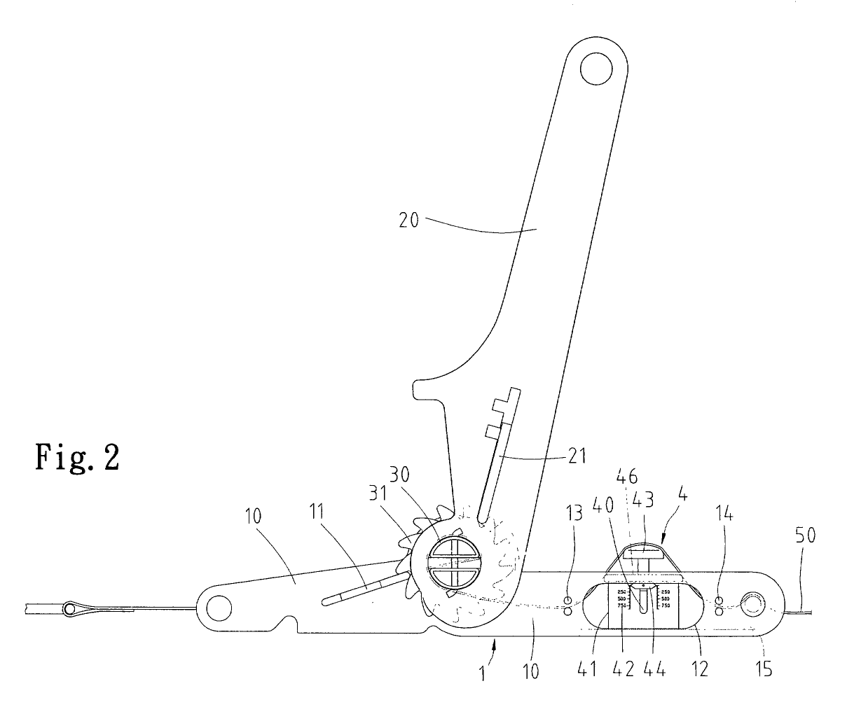

FIG. 3 is a cross-sectional view of the strap fastener and the force gauge shown in FIG. 2.

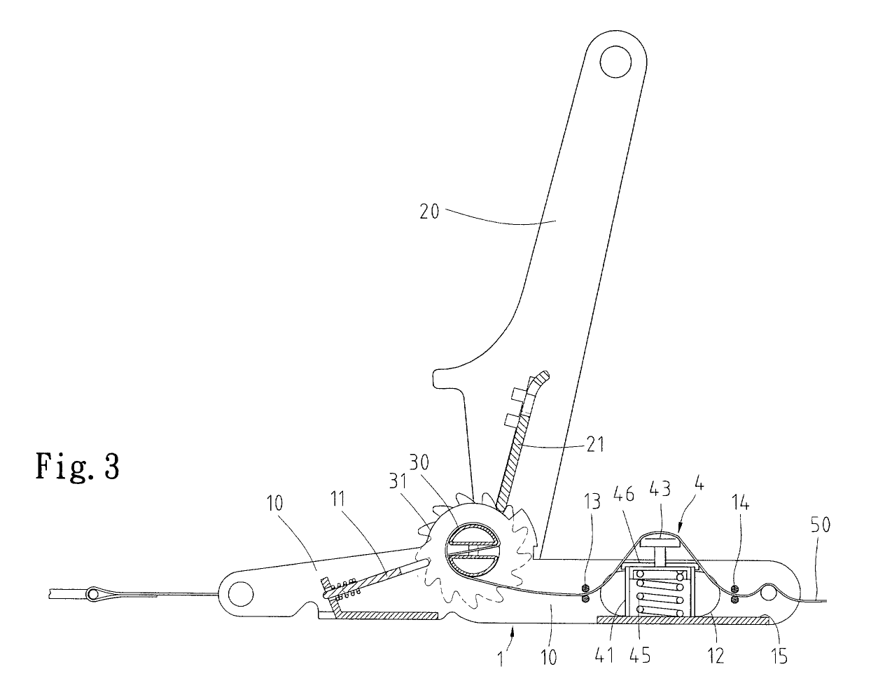

FIG. 4 is a side view of the strap fastener and the force gauge shown in FIG. 1 in a second position.

FIG. 5 is a cross-sectional view of the strap fastener and the force gauge shown in FIG. 4.

### DETAILED DESCRIPTION OF PREFERRED EMBODIMENT

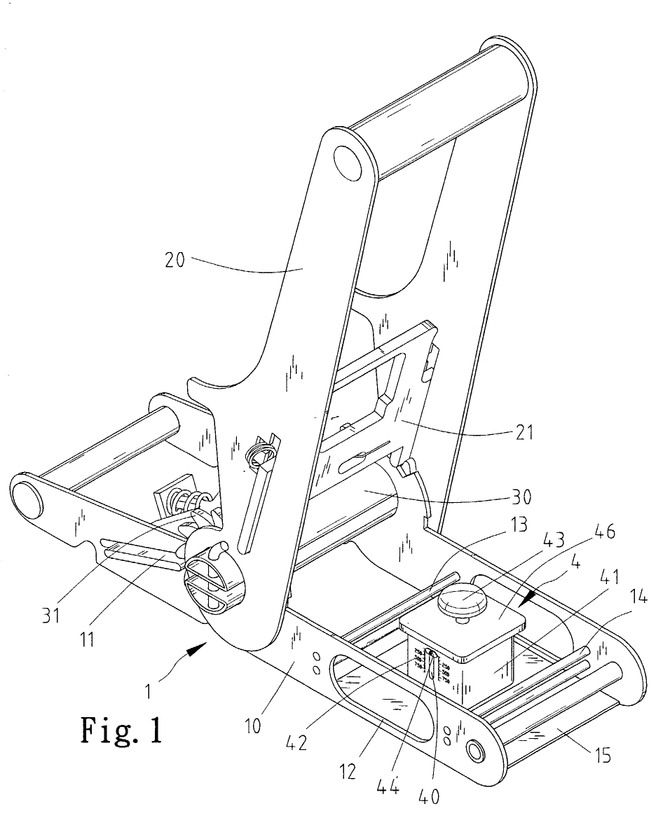

Referring to FIGS. 1˜5, a strap fastener 1 is equipped with a force gauge 4 according to the preferred embodiment of the present invention. The strap fastener 1 includes a base 10, a lever 20, an axle 30, two ratchet wheels 31, a first detent 11 and a second detent 21.

The base 10 includes two side elements. One of the side elements of the base 10 defines a window 12. A first pair of guiding elements 13 is formed between the side elements of the base 10. A second pair of guiding elements 14 is formed between the side elements of the base 10. A platform 15 is formed between the side elements of the base 10.

The axle 30 is rotationally mounted on the base 10. The ratchet wheels 31 are secured to the axle 30. The first detent 11 is biased by a spring. The first detent 11 is mounted on the base 10 for engagement with the ratchet wheels 31. Thus, rotation of the axle 30 relative to the base 10 in a first direction is allowed, but rotation of the axle 30 in a second direction opposite to the first direction is avoided.

The lever 20 is pivotally mounted on the axle 30. The second detent 21 is biased by a spring that is not shown for clarity of the drawings. The second detent 21 is mounted on the lever 20 for engagement with the ratchet wheels 31. Thus, pivoting of the lever 20 in the first direction results in rotation of the axle 30 in the first direction, but pivoting of the lever 20 in the second direction does not entail rotation of the axle in the second direction.

The force gauge 4 is mounted on the platform 15. The force gauge 4 includes a casing 41 mounted on the platform 15. The casing 41 includes a slot 40 defined therein and a scale 42 formed thereon via printing or carving. The slot 40 and the scale 42 extend side by side. A spring 45 is received in the casing 41. An anvil 43 includes a first disk mounted on the spring 45 and received in the casing 41, a second disk located beyond the casing 41 and a rod formed between the first and second disks. A cap or ring 46 is mounted on the casing 41 so as to retain the spring 45 and the first disk of the anvil 43 in the casing 41. An indicator 44 is secured to the first disk of the anvil 43 by means of a pin (not numbered) extending through the slot 40.

A strap 50 is wound on the axle 30, inserted between the guiding elements 13, led past the second disk of the anvil 43, and inserted between the guiding elements 14.

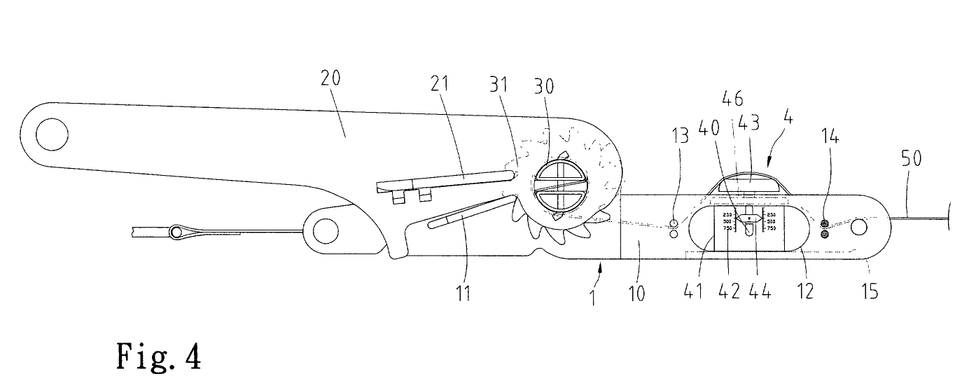

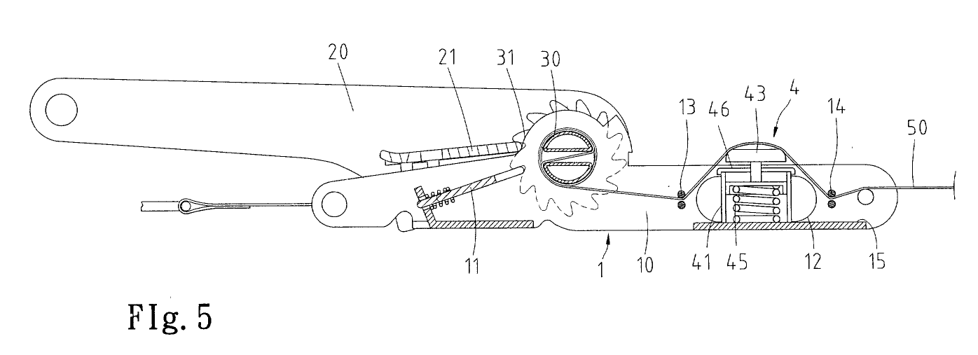

Referring to FIGS. 4 and 5, when subject to a tensile force, due to the directing of the guiding elements 13 and 14, the strap 50 pushes the second disk of the anvil 43, i.e., compresses the spring 45. The indicator 44 is accordingly moved downward so as to point at a value in the scale 42. The indicator 44 can be observed through the window 12.

The present invention has been described via illustration of the preferred embodiment. The applicant gives the preferred embodiment only as an example, and those skilled in the art can derive variations from the preferred embodiment after a study of this specification. Therefore, the preferred embodiment shall not limit the scope of the present invention that is defined in the following claims.

What is claimed is:

1. A force-indicating strap fastener including:
a base including a first guiding element formed thereon and a second guiding element formed thereon;
an axle rotationally mounted on the base;
a lever pivotally mounted on the axle;
at least one ratchet wheel secured to the axle;
a first detent mounted on the base for engagement with the at least one ratchet wheel so that rotation of the axle relative to the base in a first direction is allowed but that rotation of the axle in a second direction opposite to the first direction is avoided;
a second detent mounted on the lever for engagement with the ratchet wheels so that pivoting of the lever in the first direction results in rotation of the axle in the first direction but that pivoting of the lever in the second direction does not entail rotation of the axle in the second direction; and
a force gauge mounted on the base between the first guiding element and the second guiding element wherein a strap can be wound on the axle and directed past the first guiding element, the force gauge and the second guiding element so that when subject to a tensile force, the strap exerts a force on the force gauge.

2. The strap fastener according to claim 1 wherein the force gauge includes:
a casing mounted on the base and formed with a scale;
a spring received in the casing;
an anvil including a first end in contact with the spring and a second end outside the casing; and
an indicator connected with the anvil for pointing at a value in the scale depending on the tensile force.

3. The strap fastener according to claim 2 wherein the casing defines a slot extending by and parallel to the scale, and the indicator is connected with the anvil via a pin extending through the slot.

4. The strap fastener according to claim 2 wherein the anvil includes a disk formed at the first end for contact with the spring.

5. The strap fastener according to claim 2 wherein the anvil includes a disk formed at the second end for contact with the strap.

6. The strap fastener according to claim 2 wherein the anvil includes a first disk formed at the first end for contact with the spring, a second disk formed at the second end for contact with the strap and a rod formed between the first and second disks.

7. The strap fastener according to claim 1 including two first guiding elements between which the strap is directed.

8. The strap fastener according to claim 1 including two second guiding elements between which the strap is directed.

9. The strap fastener according to claim 1 wherein the base defines a window through which the scale and the indicator can be observed.
